(19) United States
(12) Patent Application Publication
(10) Pub. No.: US 2004/0180135 A1
(43) Pub. Date: Sep. 16, 2004

(54) Heating roller, calendering apparatus using said heating roller, and method of manufacturing magnetic recording medium using said calendering apparatus

(75) Inventors: Hiromichi Ito, Odawara-shi (JP); Katsunori Horiuchi, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 10/793,758

(22) Filed: Mar. 8, 2004

(30) Foreign Application Priority Data
Mar. 11, 2003 (JP) 2003-064345

(51) Int. Cl. G03G 19/00; F28F 5/02; B05D 5/12; B05D 3/12

(52) U.S. Cl. 427/127; 427/365; 492/8; 492/46

(57) ABSTRACT

A heating roller includes a magnetic flux generation mechanism provided in a plurality of layers coaxially around the axis of a roller in the roller capable of being supported rotatably, and a control device capable of independently controlling the layers of the magnetic flux generation mechanism.

### BACKGROUND OF THE INVENTION

1. Field of the Invention

The present invention relates to a heating roller, a calendering apparatus using the heating roller, and a method of manufacturing a magnetic recording medium using the calendering apparatus. More particularly, it relates to a heating roller suitable for performing calendering by passing a sheet-shaped object such as a magnetic tape between a pair of rollers to press it, a calendering apparatus using the heating roller, and a method of manufacturing a magnetic recording medium using the calendering apparatus.

2. Description of the Related Art

One of the manufacturing processes for manufacturing magnetic recording media such as magnetic tapes is a surface smoothing process called calendering. This process is carried out by pressing a magnetic tape using a pair of rollers to improve the smoothness and packing density of magnetic layer surface. As the rollers, a metallic roller having a metal surface and an elastic roller having a surface formed of a resin, etc. are generally combined.

Typically, the metallic roller is used as a heating roller. This heating roller often employs a roller construction in which an induction heat generation mechanism is arranged in a rotating hollow roller to induction heat the peripheral wall of the roller.

FIG. 4 is a sectional view for illustrating the construction of the above-described conventional heating roller 1. In the heating roller 1, a coil 2, which is the induction heat generation mechanism, is arranged. An eddy current is generated in a shell 3, which is the peripheral wall, by a magnetic field produced by the coil 2, and Joule heat is generated by the eddy current. Therefore, the heating roller 1 is a roller of induction heating type.

The coil 2 is supplied with power from a rotary transformer 4 at the left end of a shaft via lead wires 5, 5, . . . by a power source 8 (see FIG. 5). At a part of the shell 3, a temperature sensor 6 is embedded so that a signal from the temperature sensor 6 is used to control temperature. Also, in the shell 3, a heat pipe 7, which is a through hole, is provided so that temperature can be controlled by circulating a fluid in the heat pipe 7.

There has been proposed a construction in which a plurality of magnetic flux generation mechanisms are arranged along the axial direction of the roller to provide a plurality of temperature regions of roller (see Japanese Examined Patent Application Publication No. 62-17359). It is said that by distributing temperature in the axial direction of heating roller in this manner, the effects that can stabilize the performance of products and increase the yield can be anticipated.

However, according to the construction described in Japanese Examined Patent Application Publication No. 62-17359, although temperature can be distributed in the axial direction of heating roller, it is not easy to address various temperature distributions conforming to the product specifications. Further, the construction described in Japanese Examined Patent Application Publication No. 62-17359 has a problem in that uniform temperature distribution cannot be obtained because a drop in magnetic flux is produced between coils.

Another construction can be thought in which axial winding distribution is provided on the induction coil of heating roller to address various temperature distributions, such as a construction in which the winding distribution only in the central portion in the axial direction is denser than that in other portions, a construction in which the winding distribution in only both end portions in the axial direction is denser than that in other portions, and the like. FIG. 5, which shows an example of the latter construction, is a schematic view showing a method of controlling the conventional heating roller 1.

In FIG. 5, the heating roller 1 has almost the same construction as that shown in FIG. 4. Therefore, the explanation of duplicated portions is omitted. In FIG. 5, power is supplied to the coil 2 by the power source 8. The power source 8 is connected to a controller 9, so that the power source 8 is controlled by the controller 9. The temperature sensor 6 is connected to the controller 9, and a signal from the temperature sensor 6 is used to control temperature. In the above-described construction shown in FIG. 5, the coil 2 consists of one wire, which is controlled by one power source 8.

In the heating roller 1 constructed as described above, it is necessary to address various temperature distributions by replacing the heating roller 1 each time the product specifications differ. Depending on the size (heat capacity) of the heating roller 1, specifications (service temperature), etc., the operation sometimes requires about three hours only for cooling of the heating roller 1, resulting in a decreased availability. In addition, a plurality of heating rollers 1 that conform to the product specifications must be kept in stock, which is a burden on facilities.

### SUMMARY OF THE INVENTION

The present invention has been made in view of the above situation, and accordingly an object thereof is to provide a heating roller that is suitable for performing calendering by passing a sheet-shaped object such as a magnetic tape between a pair of rollers to press it and can quickly provide various temperature distributions, a calendering apparatus using the heating roller, and a method of manufacturing a magnetic recording medium using the calendering apparatus.

To achieve the above object, the present invention provides a heating roller including a magnetic flux generation mechanism provided in a plurality of layers coaxially around the axis of a roller in the roller capable of being supported rotatably, and a control device capable of independently controlling the layers of the magnetic flux generation mechanism; a calendering apparatus using the heating roller; and a method of manufacturing a magnetic recording medium using the calendering apparatus.

According to the present invention, the magnetic flux generation mechanism is provided in a plurality of layers coaxially around the axis of a roller in the roller, and the layers of the magnetic flux generation mechanism can be controlled independently. Therefore, for example, the magnetic flux generation mechanism having a three-layer construction is provided, and the innermost layer of magnetic flux generation mechanism can comprise an induction coil having a uniform winding distribution, the intermediate layer of magnetic flux generation mechanism can comprise an induction coil configured so that the winding distribution in only the central portion in the axial direction is denser than that in other portions, and the outmost layer of magnetic flux generation mechanism can comprise an induction coil configured so that the winding distribution in only both end portions in the axial direction is denser than-that in other portions. If each layer of magnetic flux generation mechanism is controlled independently, a heating roller capable of quickly providing various temperature distributions can be provided.

As the “magnetic flux generation mechanism”, an induction coil is generally used.

In the present invention, it is preferable that the magnetic flux generation mechanism be an induction coil, and the winding density along the axis of the roller of at least one layer of the induction coil be partially different. By this configuration, the object of the present invention can be achieved easily.

As described above, according to the present invention, the magnetic flux generation mechanism is provided in a plurality of layers coaxially around the axis of a roller in the roller, and the layers of the magnetic flux generation mechanism can be controlled independently. Therefore, for example, the magnetic flux generation mechanism having a three-layer construction is provided, and the innermost layer of magnetic flux generation mechanism can comprise an induction coil having a uniform winding distribution, the intermediate layer of magnetic flux generation mechanism can comprise an induction coil configured so that the winding distribution in only the central portion in the axial direction is denser than that in other portions, and the outmost layer of magnetic flux generation mechanism can comprise an induction coil configured so that the winding distribution in only both end portions in the axial direction is denser than that in other portions. If each layer of magnetic flux generation mechanism is controlled independently, a heating roller capable of quickly providing various temperature distributions can be provided.

### BRIEF DESCRIPTION OF THE DRAWINGS

FIG. 1 is a schematic view showing a construction of a heating roller in accordance with the present invention;

FIGS. 2A to 2C are schematic views showing winding distribution of an induction coil of each heating roller;

FIG. 3 is a schematic view showing the whole configuration of a calendering apparatus in accordance with the present invention;

FIG. 4 is a sectional view for illustrating a construction of a conventional heating roller; and

FIG. 5 is a schematic view showing a method of controlling a conventional heating roller.

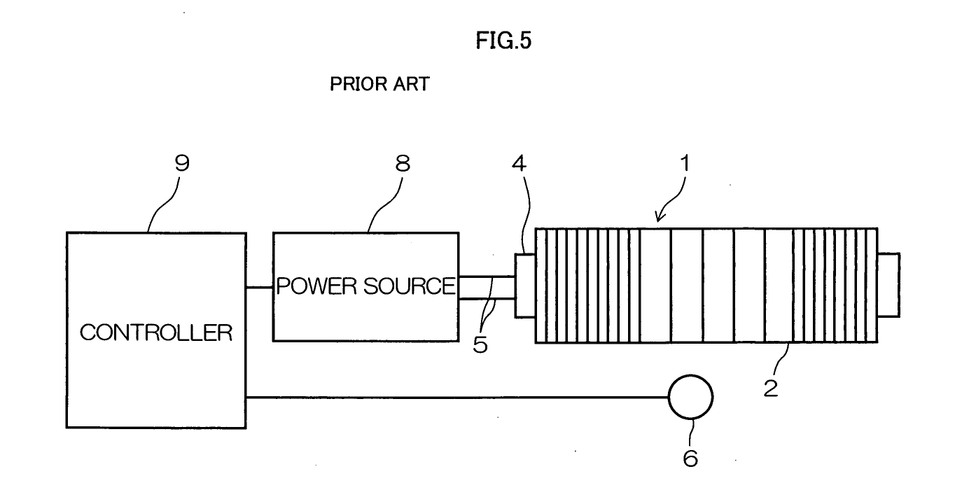

### DETAILED DESCRIPTION OF THE PREFERRED EMBODIMENTS

Preferred embodiments of a heating roller, a calendering apparatus using the heating roller, and a method of manufacturing a magnetic recording medium using the calendering apparatus in accordance with the present invention will now be described in detail with reference to the accompanying drawings.

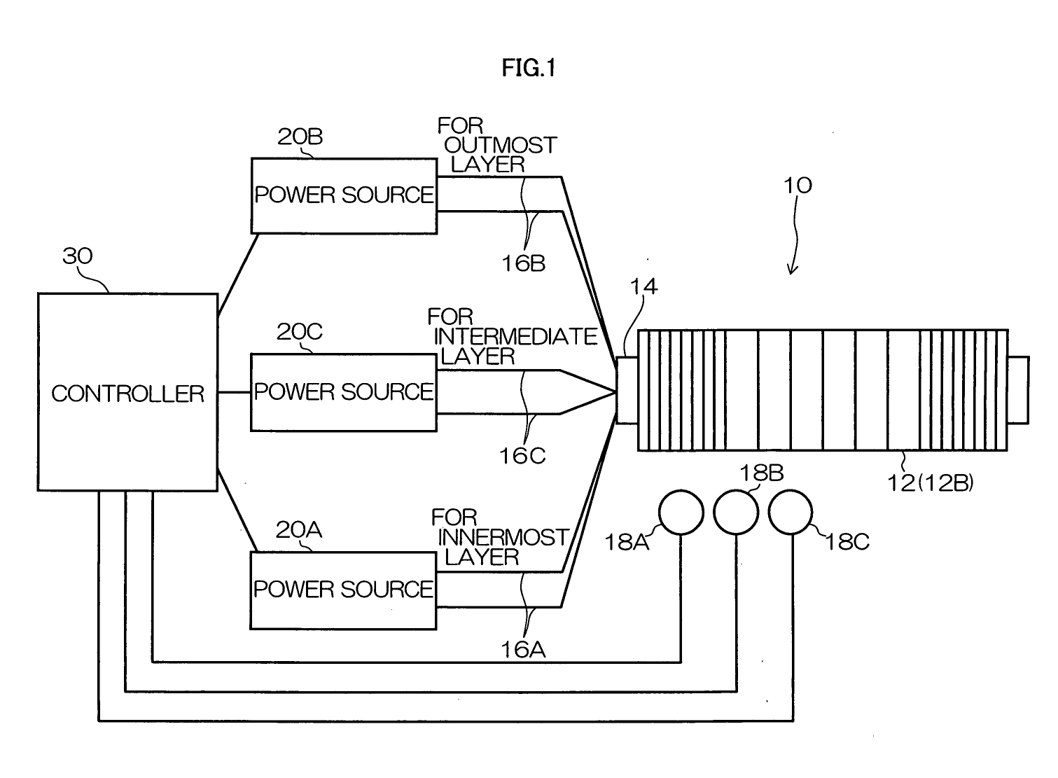

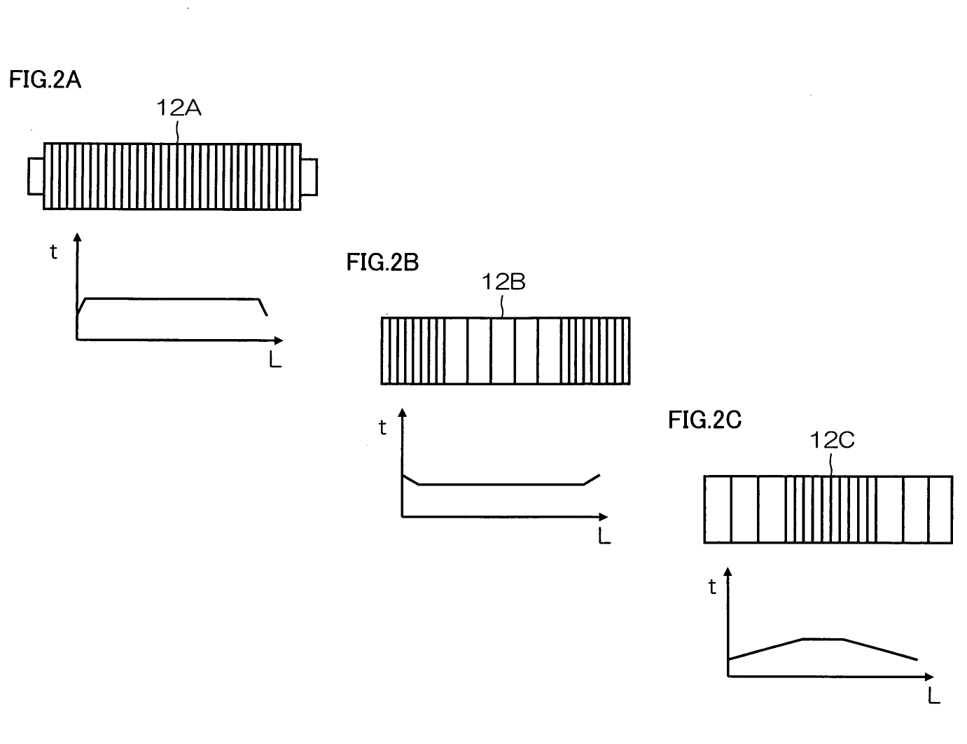

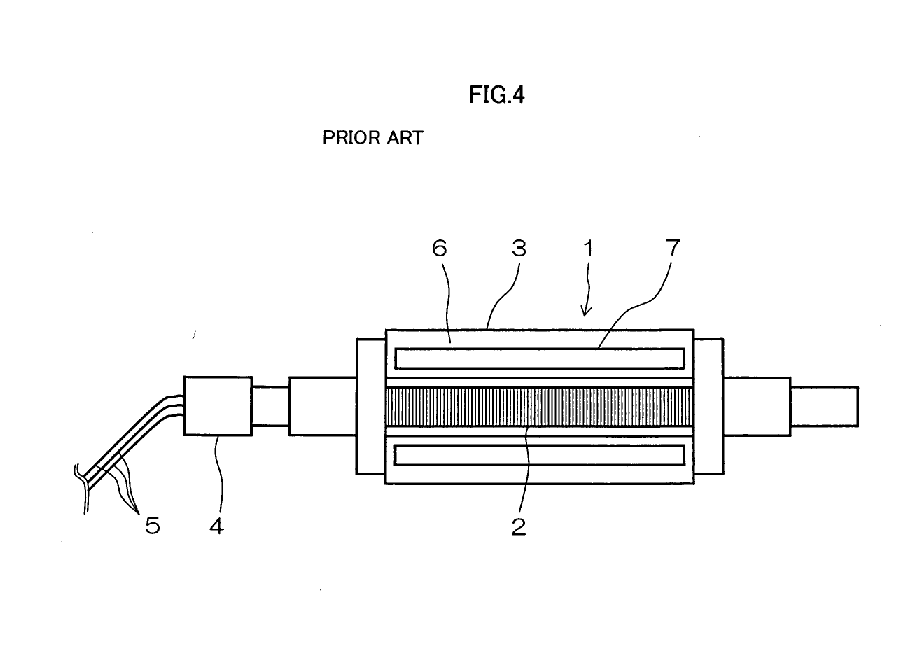

FIG. 1 is a schematic view showing a construction of a heating roller 10 in accordance with the present invention. FIGS. 2A to 2C are schematic views showing winding distribution of an induction coil (coil 12) of each heating roller 10. The whole construction of the heating roller 10 is the same as that of the conventional example shown in FIG. 4 except the coil 12, so that the illustration thereof is omitted. The heat pipe 7 shown in FIG. 4 is not an indispensable element in the present invention, and therefore can be omitted.

In the heating roller 10 that can be supported rotatably, the coil 12, which is a magnetic flux generation mechanism, is provided around the axis of roller along the axis of roller. The coil 12 is provided in three layers coaxially around the axis of roller. Specifically, the coil 12 is a three-layer induction coil comprising an innermost-layer coil 12A, an intermediate-layer coil 12C, and an outermost-layer coil 12B shown in FIGS. 2A to 2C. In FIG. 1, only the outermost-layer coil 12B is shown.

The coil 12A shown in FIG. 2A is an induction coil having uniform winding distribution, which is arranged in the innermost layer. The distribution of surface temperature t of a shell (peripheral wall) of the heating roller 10 provided by the coil 12A is substantially uniform in the direction of length L as shown in the graph in FIG. 2A.

The coil 12B shown in FIG. 2B is an induction coil configured so that the winding distribution in only both end portions in the axial direction is denser than that in other portions, which is arranged in the outermost layer. The distribution of surface temperature t of the shell (peripheral wall) of the heating roller 10 provided by the coil 12B has a pattern such that the surface temperature is high in only both end portions in the direction of length L as shown in the graph in FIG. 2B.

The coil 12C shown in FIG. 2C is an induction coil configured so that the winding distribution only in the central portion in the axial direction is denser than that in other portions, which is arranged in the intermediate layer. The distribution of surface temperature t of the shell (peripheral wall) of the heating roller 10 provided by the coil 12C has a pattern such that the surface temperature is high in only the central portion in the direction of length L and decreases gradually toward both ends as shown in the graph in FIG. 2C.

Each layer of the coil 12 is supplied with power from a rotary transformer 14 at the left end of a shaft via lead wires 16, 16, . . . by a power source 20. Specifically, the coil 12A (innermost layer) is supplied with power via lead wires 16A, 16A by a power source 20A, the coil 12B (outermost layer) is supplied with power via lead wires 16B, 16B by a power source 20B, and the coil 12C (intermediate layer) is supplied with power via lead wires 16C, 16C by a power source 20C.

The power sources 20 each are connected to a controller 30, so that the power sources 20 are controlled independently by the controller 30. Temperature sensors 18 (18A, 18B, 18C), each of which is embedded in a part of the shell of the heating roller 10, are connected to the controller 30. Thereby, the power supply to the coil 12 is controlled properly.

The kind, number, installation position, etc. of the temperature sensor 18 are not subject to any restriction, and any type thereof can be used. Usually, a thermocouple of sheath type is used. Additionally, an infrared thermometer of radiation type, a platinum resistance temperature sensor, a thermistor, or any other type of temperature sensor can be used. Also, a configuration can be used in which in place of the temperature sensor 18, a gloss sensor, a thickness sensor, a roughness sensor, a displacement sensor, or any other sensor is used so that the physical quantity etc. of a work (magnetic tape or the like) is detected to feed back the detected value.

In the configuration shown in FIG. 1, when a thermocouple is used as the temperature sensor 18, it is preferable that the temperature sensor 18 be embedded in a portion of the shell at a location at which the control of each layer of the coil 12 can be carried out properly. Specifically, it is preferable that the temperature sensor 18B corresponding to the coil 12B (outmost layer) be embedded at a position at which the temperature of an end portion in the direction of length L of the heating roller 10 can be monitored, the temperature sensor 18C corresponding to the coil 12C (intermediate layer) be embedded at a position at which the temperature of a central portion in the direction of length L of the heating roller 10 can be monitored, and the temperature sensor 18A corresponding to the coil 12A (innermost layer) be embedded at a position at which the temperature of an intermediate portion between the end portion and the central portion in the direction of length L of the heating roller 10 can be monitored.

The following is a description of the temperature control for the heating roller 10 described above. The temperature control for the heating roller 10 is carried out by independently controlling the voltage or frequency of each layer of coil 12 by means of the controller 30. Since the winding distribution of each layer of coil 12 has already been determined, the controllable item is only the power supplied to each layer of coil 12. By properly setting the distribution of power supplied to each layer of the coil 12, a desired temperature pattern is obtained.

For example, when it is desired to locally increase the temperature of both end portions of the heating roller 10 while the temperature of the whole of the heating roller 10 is kept at a predetermined level, 60% of the total supply power is distributed to the coil 12A (innermost layer), 40% thereof is distributed to the coil 12B (outmost layer), and 0% thereof is distributed to the coil 12C (intermediate layer).

On the other hand, when it is desired to heat only the central portion of the heating roller 10 while the temperature of the whole of the heating roller 10 is kept at a low level, 20% of the total supply power is distributed to the coil 12A (innermost layer), 0% thereof is distributed to the coil 12B (outmost layer), and 80% thereof is distributed to the coil 12C (intermediate layer).

Besides, the optimum control method suitable for the configuration (especially, material of shell, thickness of shell, etc.) of the whole of the heating roller 10, the configuration of the controller 30, the winding distribution of each coil 12, the arrangement of the temperature sensors 18, the number of the temperature sensors 18, and the like can be selected arbitrarily.

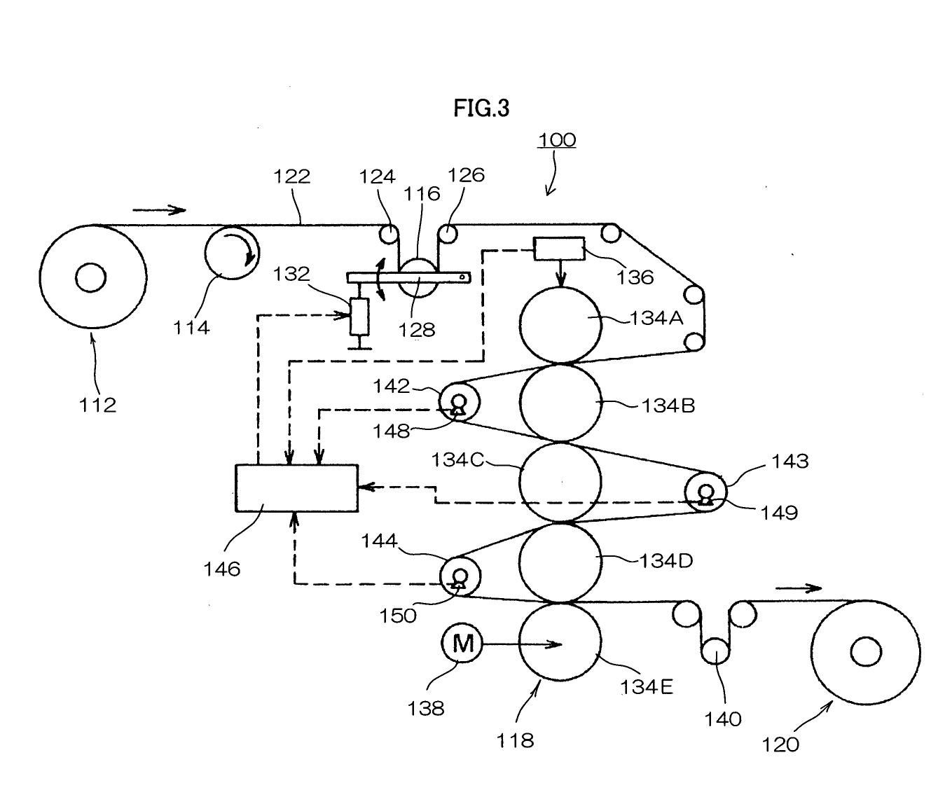

Next, a calendering apparatus using the heating roller 10 in accordance with the present invention will be described. FIG. 3 is a schematic view showing the whole configuration of a calendering apparatus 100 in accordance with the present invention. As shown in FIG. 3, the calendering apparatus 100 includes a tape feeder 112, a grooved suction drum (hereinafter abbreviated to GSD) 114, a dancer roller (corresponding to a tension adjusting device) 116, a pressing section 118, and a take-up device 120.

The tape feeder 112 is mounted with a sheet-shaped magnetic tape 122 in a state of being wound in a roll form. The magnetic tape 122 is constructed by forming a nonmagnetic layer and a magnetic layer on the surface of a sheet-shaped base material (not shown) and by forming a back coat layer on the back surface of the base material. The magnetic tape 122 is sent out from the tape feeder 112 by the rotation of the GSD 114. The GSD 114 is a drum which rotates while attracting the magnetic tape 122 to the surface thereof by sucking air into the interior thereof, and the surface thereof is formed with grooves for increasing a force for holding the magnetic tape 122. In place of the GSD 114, a suction drum having a flat surface or a pair of rollers (not shown) may be used to convey the magnetic tape 122.

The magnetic tape 122 sent out by the GSD 114 is sent to the pressing section 118 through the dancer roller 116. The dancer roller 116 is hung by the magnetic tape 122 between guide rollers 124 and 126, and also is supported by a support arm 128. The support arm 128 is supported so as to be swayable around one end (right-hand side in FIG. 3), and at the other end (left-hand side in FIG. 3) of the support arm 128 is provided a cylinder 132. The dancer roller 116 is moved up and down by pulling the support arm 128 using the cylinder 132, by which the tension in an infeed portion of the magnetic tape 122 is adjusted. The infeed portion means a portion ranging from the GSD 114 to the pressing section 118.

The magnetic tape 122, in which high tension has been given to the infeed portion thereof, is sent to the pressing section 118. The pressing section 118 is made up of five stages of metallic rollers 134A to 134t stacked in the vertical direction. Each of the metallic rollers 134A to 134E is provided so as to be rotatable around a horizontal axis. The surface of each of the metallic rollers 134A to 134E is subjected to hard chromium plating to increase hardness and wear resistance.

Of the above-described metallic rollers 134A to 134E, the rollers 134A, 134C and 134E have the same specifications as those of the aforementioned heating roller 10. The surfaces of the rollers 134A, 134C and 134E can be heated to 60 to 120° C. On the other hand, the rollers 134B and 134D are backup rollers. The rollers 134B and 134D, which are backup rollers, may be provided with a water jacket pipe to perform a function as a cooling roller.

Of the metallic rollers 134A to 134E, the metallic roller 134E of the lowest stage is configured so that the position of the axis of rotation is fixed, while other metallic rollers 134A to 134D are configured so as to be capable of moving vertically while the axis of rotation is kept in the horizontal state. Also, the metallic roller 134E of the lowest stage is connected with a motor 138 for rotating the metallic roller 134E, and the metallic roller 134A is provided with an urging device 136 for urging the metallic roller 134A downward. By urging the metallic roller 134A downward using the urging device 136, the metallic rollers 134A to 134E are brought into close contact with each other.

By rotating the metallic roller 134E in this state, the metallic rollers 134A to 134D are rotated following the metallic roller 134E. The configuration is such that when the urging force by the urging device 136 is released, the metallic rollers 134A to 134D move upward, so that gaps are formed between the metallic rollers 134A to 134E. The magnetic tape 122 is set so as to pass through these gaps and to be wound on guide rollers 142, 143 and 144. By urging the metallic roller 134A downward using the urging device 136 to bring the metallic rollers 134A to 134E into close contact with each other, the magnetic tape 122 is held between the metallic rollers 134A to 134E.

The magnetic tape 122 having been held and pressed by the metallic rollers 134A to 134E is wound up on the take-up device 120. At this time, in order to prevent the magnetic tape 122 from being distorted, it is preferable that when the thickness of the magnetic tape 122 is about 10 μm, the tension of the magnetic tape 122 be not higher than 10 kg per 1m width. Between the metallic roller 134E and the take-up device 120, a dancer roller 140 is provided to absorb fluctuations in tension of the magnetic tape 122.

Further, a configuration can be used in which the tension of the magnetic tape 122 having been pressed is detected, and the tension of the magnetic tape 122 before being pressed is adjusted according to the detection value. This configuration is explained briefly. In both end portions of the guide rollers 142 to 144, load cells (tension measuring devices) 148 to 150 are incorporated to measure the tension of the magnetic tape 122 wound on the guide rollers 142 to 144.

The load cells 148 to 150 for the guide rollers 142 to 144 are connected to a controller 146. The controller 146 controls the cylinder 132 based on the detection values of the load cells 148 to 150 to adjust the tension in the infeed portion of the magnetic tape 122. For example, when the tension of the magnetic tape 122 on any of the guide rollers 142 to 144 is lower than a setting value (or setting range), the tension in the infeed portion of the magnetic tape 122 is increased by the cylinder 132. Inversely, when the tension of the magnetic tape 122 on any of the guide rollers 142 to 144 is higher than a setting value (or setting range), the tension in the infeed portion of the magnetic tape 122 is decreased by the cylinder 132.

The controller 146 controls the cylinder 132 according to the timing at which the urging device 136 urges the metallic roller 134A. Specifically, at the same time that the metallic roller 134A is urged by the urging device 136, high tension is provided to the infeed portion of the magnetic tape 122 by the cylinder 132, and at the same time that the urging operation by the urging device 136 is stopped, the provision of high tension due to the cylinder 132 is stopped. Thereby, high tension is provided to the infeed portion of the magnetic tape 122 only during the time when the magnetic tape 122 is held between the magnetic rollers 134A to 134E.

Next, the operation of the calendering apparatus 100 configured as described above will be explained. First, the magnetic tape 122 is run by the GSD 114 and the take-up device 120. At this time, the cylinder 132 is not driven and the urging force by the urging device 136 is released, so that the magnetic tape 122 runs between the magnetic rollers 134A to 134E in a state of low tension.

After the speed of the magnetic tape 122 has become constant at a low speed, the magnetic tape 122 begins to be pressed. Specifically, the metallic roller 134A is urged downward by the urging device 136 to bring the magnetic rollers 134A to 134E into close contact with each other, whereby the magnetic tape 122 is held therebetween. Thereby, the magnetic tape 122 is pressed while the metallic rollers 134A to 134D are rotated following the metallic roller 134E.

At the same time or immediately after the magnetic tape 122 begins to be pressed, high tension is provided to the infeed portion of the magnetic tape 122 by the cylinder 132. Differing depending on the kind and thickness of the magnetic tape 122 and the calendering conditions, the magnitude of the tension is preferably about 20 to 40 kg per 1 m width when the thickness of the magnetic tape 122 is about 10 μm. By applying such high tension, the magnetic tape 122 is expanded in the lengthwise direction.

After the high tension has been applied to the magnetic tape 122, the speed of the magnetic tape 122 is increased to run the magnetic tape 122 at a high speed. The magnetic tape 122 running at the high speed is wound up on the take-up device 120.

When the heating roller 10 in accordance with the present invention is used in the above-described calendering apparatus 100, that is, when the rollers 134A, 134C and 134E shown in FIG. 3 have the same specifications as those of the aforementioned heating roller 10, the temperature distribution of each roller 134 can be controlled arbitrarily. Therefore, it is easy to address various temperature distributions corresponding to the product specifications, so that the roller is significantly effective for increased availability, alleviated burden on facilities, upgraded quality of magnetic recording medium, etc.

The above is a description of embodiments of a heating roller in accordance with the present invention, a calendering apparatus using the heating roller, and a method of manufacturing a magnetic recording medium using the calendering apparatus. The present invention is not limited to the above-described embodiments, and various modes can be used. For example, the construction of the heating roller 10, and the material, shape, etc. of the shell are not subject to any restriction, and an arbitrary construction etc. can be used.

Also, although the metallic rollers 134A to 134E of the calendering apparatus 100 are arranged in five stages in the above-described embodiment, the number of the metallic rollers 134A to 134E is not limited to five. The number thereof may be four or smaller or six or larger. Also, a plurality of sets of metallic rollers may be arranged so that opposed two metallic rollers are made one set.

What is claimed is:

1. A heating roller comprising:
a magnetic flux generation mechanism provided in a plurality of layers coaxially around the axis of a roller in said roller capable of being supported rotatably; and
a control device capable of independently controlling the layers of said magnetic flux generation mechanism.

2. The heating roller according to claim 1, wherein said magnetic flux generation mechanism is an induction coil, and the winding density along the axis of said roller of at least one layer of said induction coil is partially different.

3. A calendering apparatus provided with one or more heating rollers of claim 1.

4. A calendering apparatus provided with one or more heating rollers of claim 2.

5. A method of manufacturing a magnetic recording medium using the calendering apparatus according to claim 3, said method having a step for calendering the magnetic recording medium in which a magnetic layer is formed on a band-shaped flexible base material.

6. A method of manufacturing a magnetic recording medium using the calendering apparatus according to claim 4, said method having a step for calendering the magnetic recording medium in which a magnetic layer is formed on a band-shaped flexible base material.
